(19) United States
(12) Patent Application Publication
(10) Pub. No.: US 2014/0233777 A1
(43) Pub. Date: Aug. 21, 2014

(54) SPEAKER ASSEMBLY AND ELECTRONIC DEVICE USING SAME

(71) Applicant: Chiun Mai Communication Systems, Inc., New Taipei (TW)

(72) Inventors: CHI-SHENG TSENG, New Taipei (TW); YI-HUNG KUO, New Taipei (TW); CHING-MING HUNG, New Taipei (TW); KUANG-HSIEN WANG, New Taipei (TW)

(73) Assignee: CHIUN MAI COMMUNICATION SYSTEMS, INC., New Taipei (TW)

(21) Appl. No.: 14/014,656

(22) Filed: Aug. 30, 2013

(30) Foreign Application Priority Data
Feb. 21, 2013 (TW) 102203308

(51) Int. Cl. H04R 1/02

(52) U.S. Cl. CPC H04R 1/021
USPC 381/332

(57) ABSTRACT

A speaker assembly is configured for assembly to a housing. The housing defines a through hole and a receiving groove communicating with each other. The speaker assembly includes a speaker and a speaker cover. The speaker is received in the through hole. The speaker cover has an extending edge beyond a peripheral wall of the speaker and is received in the receiving groove.

### BACKGROUND

1. Technical Field

The disclosure generally relates to speaker assemblies, and particularly to a speaker assembly used in an electronic device.

2. Description of the Related Art

An electronic device, such as a mobile phone has a speaker assembled in an opening of a housing. The speaker often requires a sound channel. To seal the sound channel, the speaker needs to be positioned under the housing and the housing needs an extending edge around the opening pressing against the speaker. However, the speaker is under the housing of the electronic device, and may take up some of the internal space of the electronic device which is not compatible to miniaturization of portable electronic devices.

Therefore, there is room for improvement within the art.

### BRIEF DESCRIPTION OF THE DRAWINGS

Many aspects of an exemplary speaker assembly can be better understood with reference to the following drawings. The components in the drawings are not necessarily drawn to scale, the emphasis instead being placed upon clearly illustrating the principles of the exemplary speaker assembly. Moreover, in the drawings, like reference numerals designate corresponding parts throughout the several views. Wherever possible, the same reference numbers are used throughout the drawings to refer to the same or like elements of an embodiment.

FIG. 1 is an exploded view of a speaker assembly used in an electronic device, according to an exemplary embodiment.

FIG. 2 is an assembled view of the electronic device shown in FIG. 1.

FIG. 3 is a cross-sectional view of the speaker assembly along line III-III of FIG. 2.

### DETAILED DESCRIPTION

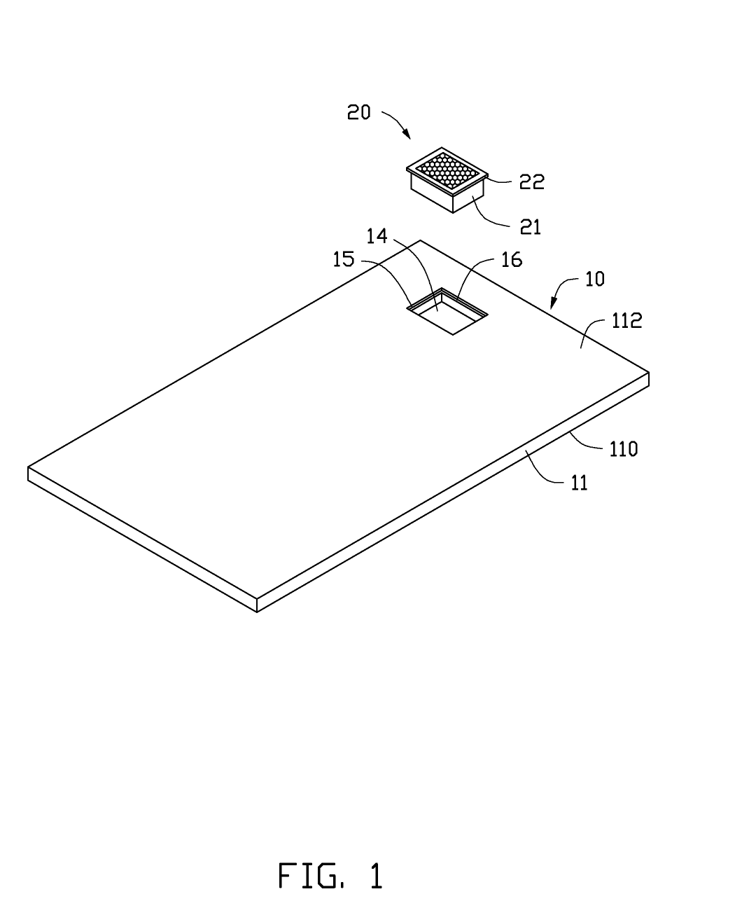

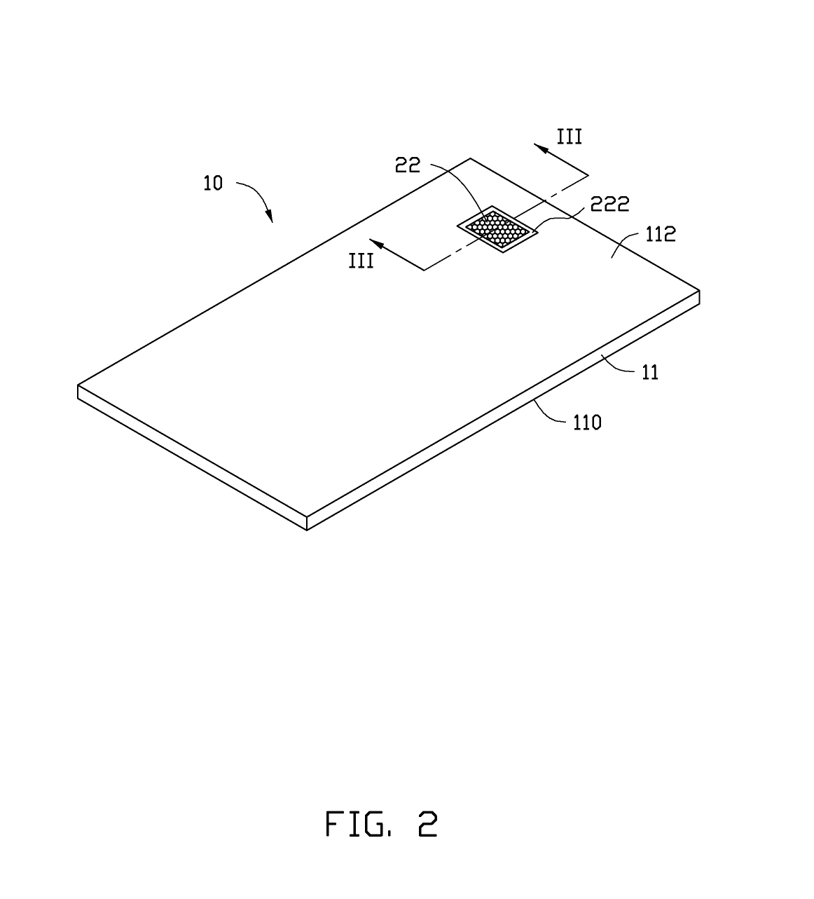

FIGS. 1-2 show a speaker assembly 20 according to an exemplary embodiment, The speaker assembly 20 is used in an electronic device such as a mobile phone, a personal digital assistant (PDA). The electronic device includes a housing 10. In this exemplary embodiment, the housing 10 is a front housing of the electronic device. The housing 10 has a base plate 11.

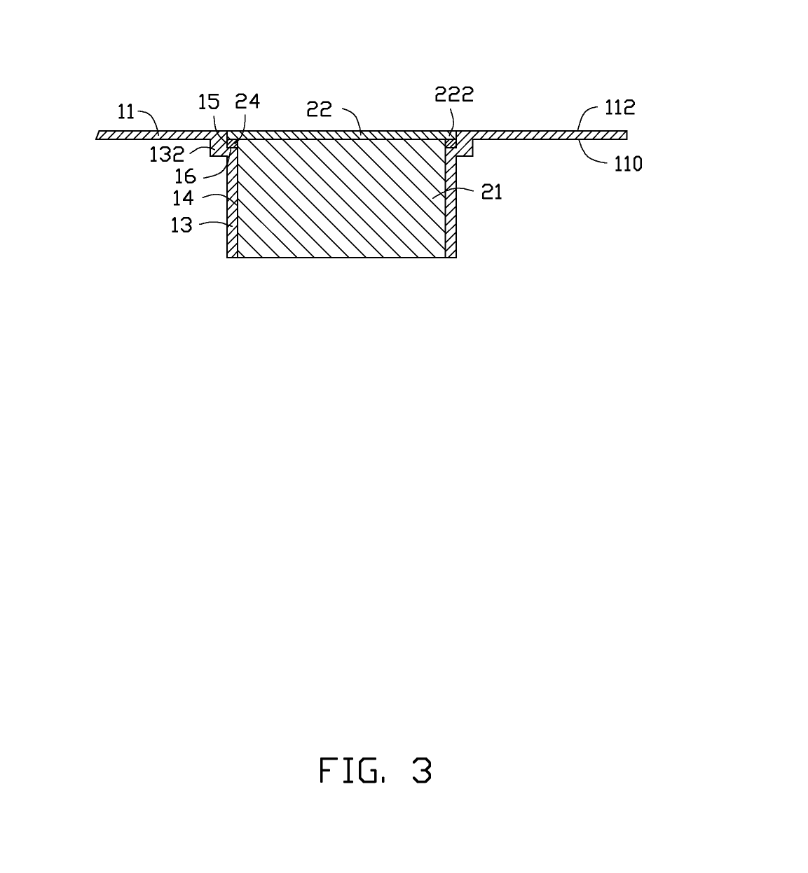

FIG. 3 shows that the base plate 11 can be one portion of the housing 10, or an independent component attached to the housing 10. In the embodiment, the base plate 11 is integrated with the housing 10. The base plate 11 includes a first surface 112 and a second surface 110 opposite to the first surface 112. In this exemplary embodiment, the first surface 112 is an external surface of the housing 10, and the second surface 110 is an internal surface of the housing 10. A frame 13 extends from the second surface 110 and has a stepped portion 132 connected to the second surface 110. The frame 13 defines a through hole 14 and a receiving groove 15 communicating with each other. The receiving groove 15 extends through the first surface 112. The receiving groove 14 is larger than the through hole 14, thereby forming a supporting surface 16 extending continuously around all sides of the through hole 14.

The speaker assembly 20 includes a speaker 21, a speaker cover 22 and a sealing member 24. The speaker 21 is received in the through hole 14. The speaker cover 22 is attached to one end of the speaker 21 by, e.g., adhesive. The speaker cover 22 has an extending edge 222 beyond a peripheral wall of the speaker 21 corresponding to the receiving groove 15. The sealing member 24 is made of sealing material, such as foam. The sealing member 24 is positioned on the supporting surface 16 and is pressed by the extending edge 222 of the speaker cover 22.

In assembly, the sealing member 24 is positioned in the receiving groove 15 of the housing 10, and is supported by the supporting surface 16. Then, the speaker 21 extends through the through hole 14 of the frame 13, and the speaker cover 22 is received in the receiving groove 15. The extending edge 222 presses the sealing member 24. Accordingly, the sealing member 24 is positioned between the speaker cover 21 and the supporting surface 16 for sealing the speaker 21.

The speaker cover 21 is attached to the first surface 112 which is an external surface of the housing 10, and then the inner space of the housing 10 is saved. The sealing member 224 is located between the speaker cover 21 and the housing 10 for improving the seal of the speaker 21.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of exemplary disclosure to the full extent indicated by the broad general meaning of the terms in which the appended claims are expressed.

What is claimed is:

1. A speaker assembly configured for assembled to a housing, the housing defining a through hole and a receiving groove communicating with each other, comprising:
a speaker; and
a speaker cover, the speaker being received in the through hole, the speaker cover having an extending edge beyond a peripheral wall of the speaker and being received in the receiving groove.

2. The speaker assembly as claimed in claim 1, further comprising a sealing member, wherein the receiving groove is larger than the through hole, thereby forming a supporting surface extending continuously around all sides of the through hole, the sealing member is made of sealing material, the sealing member is positioned on the supporting surface and is pressed by the extending edge of the speaker cover.

3. The speaker assembly as claimed in claim 1, wherein the speaker cover is adhered to one end of the speaker.

4. The speaker assembly as claimed in claim 1, wherein the housing has a base plate, the base plate includes a first surface and a second surface opposite to the first surface, a frame extends from the second surface, the through hole and the receiving groove extend through the frame, and the receiving groove extends through the first surface.

5. The speaker assembly as claimed in claim 4, wherein the frame has a stepped portion connected to the second surface.

6. An electronic device, comprising:
a housing including a base plate, the base plate defining a through hole and a receiving groove communicating with each other, the receiving groove being larger than the through hole, thereby forming a supporting surface extending continuously around all sides of the through hole; and
a speaker assembly including a speaker and a speaker cover, the speaker being received in the through hole, the speaker cover having an extending edge beyond a peripheral wall of the speaker and being received in the receiving groove.

7. The electronic device as claimed in claim 6, further comprising a sealing member, wherein the sealing member is made of sealing material, the sealing member is positioned on the supporting surface and is pressed by the extending edge of the speaker cover.

8. The electronic device as claimed in claim 6, wherein the speaker cover is adhered to one end of the speaker.

9. The electronic device as claimed in claim 6, wherein the base plate includes a first surface and a second surface opposite to the first surface, a frame extends from the second surface, the through hole 14 and the receiving groove extend through the frame, and the receiving groove extends through the first surface.

10. The electronic device as claimed in claim 9, wherein the frame has a stepped portion connected to the second surface.
